(19) United States
(12) Patent Application Publication
(10) Pub. No.: US 2010/0200311 A1
(43) Pub. Date: Aug. 12, 2010

(54) Manually operatable motorized wheel chair

(75) Inventors: Tung-Yung Huang, Yung Kang (TW); Chi-Wei Kuo, Yung Kang (TW); Jing-Yu Wang, Yung Kang (TW)

Correspondence Address: CHARLES E. BAXLEY, ESQUIRE, 90 JOHN STREET, SUITE 309, NEW YORK, NY, 10038, US

(73) Assignee: Southern Taiwan University

(21) Appl. No.: 12/378,092

(22) Filed: Feb. 11, 2009

(51) Int. Cl. B62D 11/06

(52) U.S. Cl. 180/6.24

(57) ABSTRACT

A motorized wheel chair includes two drive wheels rotatably attached to a frame with wheel axles, and a push rim attached to each drive wheel for being operated by the user to rotate the drive wheels, a motor driving device includes a gear secured to the wheel axle of the drive wheel, a motor attached to the drive wheel and engaged with the gear for driving the drive wheel, and an encoder attached to the drive wheel and engaged with the gear for detecting the rotating of the drive wheel, and a control device includes a processor device coupled to the motor and the encoder for receiving a signal from the encoder and for controlling the motor to operate the drive wheel.

### BACKGROUND OF THE INVENTION

1. Field of the Invention

The present invention relates to a powered or motorized wheel chair, and more particularly to a motorized wheel chair including a structure for allowing the wheel chair to be selectively or changeably moved or driven with a motor and to be selectively or changeably moved or driven manually.

2. Description of the Prior Art

Typical motorized wheel chairs comprise a frame including a seat for supporting a user, one or two foot supports attached to the front portion of the frame for supporting the feet of the user, two drive wheels rotatably attached to the lower portion of the frame for moving the wheel chair everywhere, and a conventional push rim attached to the outer portion of each drive wheel for being operated or driven manually.

Many of the users are disabled persons and may not use the drive wheel to move or drive the drive wheel with the conventional push rim, such that many typical powered or motorized wheel chairs have been developed and comprise one or more motors attached to the frame and coupled to the drive wheel for driving or rotating the drive wheel.

For example, U.S. Pat. No. 4,050,533 to Seamone, and U.S. Pat. No. 4,422,515 to Loveless disclose two of the typical powered or motorized wheel chairs each comprising two motors attached to the frame and coupled to the drive wheels with friction drives for driving or rotating the drive wheels.

However, the engagement between the drive wheels and the friction drives is not firm or effective, and the friction drives may easily slippery relative to the drive wheels when dirt or ash is attached onto the drive wheels.

U.S. Pat. No. 4,614,246 to Masse et al. discloses another typical powered or motorized wheel chair comprising a reversible electric motor for driving a front wheel. However, the typical powered or motorized wheel chair may not be selectively or changeably moved or driven manually.

U.S. Pat. No. 4,641,720 to Young discloses a further typical powered or motorized wheel chair comprising a gear box for driving a friction drive assembly which is engageable with the rear wheels. However, similarly, the typical powered or motorized wheel chair may not be selectively or changeably moved or driven manually.

U.S. Pat. No. 5,199,520 to Chen discloses a still further typical powered or motorized wheel chair comprising a driving unit and a gear assembly which connects the driving unit to the wheel. However, similarly, the typical powered or motorized wheel chair may not be selectively or changeably moved or driven manually.

U.S. Pat. No. 5,762,154 to Hsu discloses a still further typical powered or motorized wheel chair comprising a complicated structure engaged into a rear hollow cylinder. However, similarly, the typical powered or motorized wheel chair may not be selectively or changeably moved or driven manually. In addition, the power driving devices of the typical powered or motorized wheel chairs may not be attached to the typical manually operated wheel chairs, or the structure of the typical manually operated wheel chairs should be completely changed for fitting or mounting the power driving devices.

The present invention has arisen to mitigate and/or obviate the afore-described disadvantages of the conventional wheel chairs.

### SUMMARY OF THE INVENTION

The primary objective of the present invention is to provide a motorized wheel chair including a structure for allowing the wheel chair to be selectively or changeably moved or driven with a motor and to be selectively or changeably moved or driven manually.

The other objective of the present invention is to provide a motorized wheel chair including a structure for allowing the power driving device to be easily attached to the manually operated wheel chairs without changing much structure of the wheel chair.

In accordance with one aspect of the invention, there is provided a motorized wheel chair comprising a frame including a seat for supporting a user, two drive wheels rotatably attached to the frame with wheel axles, a push rim attached to each drive wheel for being operated by the user to rotate the drive wheels, a motor driving device including a first gear secured to the wheel axle of the drive wheel and moved in concert with the wheel axle of the drive wheel, a motor attached to the drive wheel and engaged with the first gear for driving the drive wheel, and an encoder attached to the drive wheel and engaged with the first gear for detecting a rotating of the drive wheel, and a control device including a processor device coupled to the motor and the encoder for receiving a signal from the encoder and for controlling the motor to operate the drive wheel.

The motor driving device includes a second gear attached to the drive wheel and engaged with the first gear for allowing the first and the second gears to be selectively driven by the drive wheel, and for allowing the drive wheel to be rotated by the first and the second gears selectively, the motor includes a spindle for coupling to the second gear.

The motor driving device includes a clutch device coupled between the spindle of the motor and the second gear. The clutch device includes a shaft engaged with the second gear. The encoder includes a rod engaged with the first gear.

The motor driving device includes a housing attached to the drive wheel, and the first and the second gears are rotatably disposed in the housing and engaged with each other. The motor driving device includes a speed change device attached to the motor.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a front perspective view of a motorized wheel chair in accordance with the present invention;

FIG. 2 is a rear perspective view of the motorized wheel chair;

FIG. 3 is a perspective view illustrating one of the drive wheels and the motor driving devices of the motorized wheel chair;

FIG. 4 is a partial exploded view of the drive wheel and the motor driving device of the motorized wheel chair;

FIG. 5 is a block diagram illustrating the electric circuit or the electric coupling of the parts or elements of the motorized wheel chair; and

FIG. 6 is another block diagram illustrating the coupling of the parts or elements of the motorized wheel chair.

### DETAILED DESCRIPTION OF THE PREFERRED EMBODIMENT

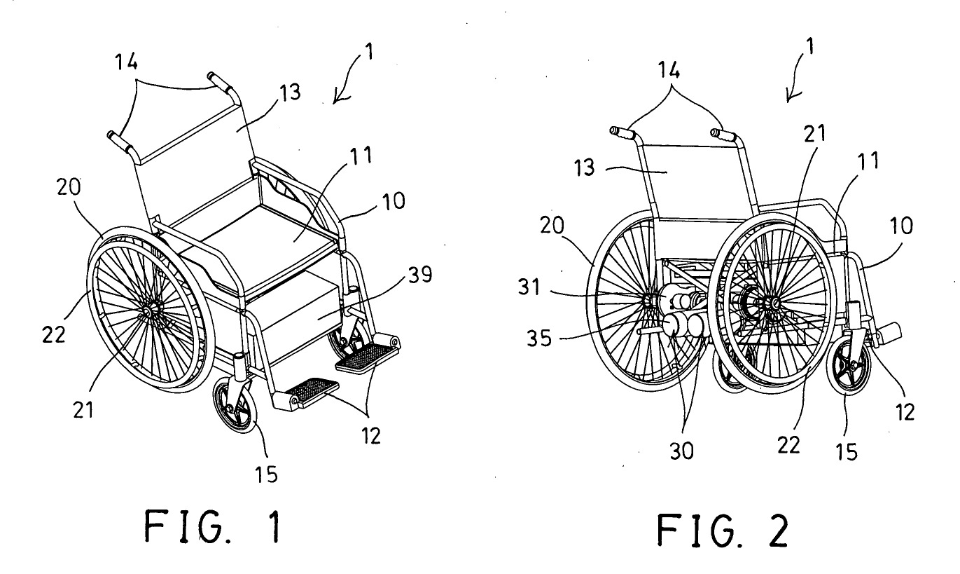

Referring to the drawings, and initially to FIGS. 1 and 2, a motorized wheel chair 1 in accordance with the present invention comprises a frame 10 including a seat 11 for supporting a user thereon, and including one or two foot supports 12 attached to the front portion of the frame 10 for supporting the feet of the user, and including a seat back 13 for supporting the back portion of the user, and including two drive wheels 20 rotatably attached to the lower portion of the frame 10 with wheel hubs or axles 21 for moving the wheel chair 1 everywhere, and including one or two handles 14 attached to the rear portion of the frame 10 for moving or maneuvering the wheel chair 1, and including two front wheels 15 attached to the front portion of the frame 10 for stably supporting the wheel chair 1.

The motorized wheel chair 1 further includes a conventional push rim 22 attached to the outer portion of each drive wheel 20 for being grasped or operated by the user and for moving or driving the wheel chair 1 and for allowing the wheel chair 1 to be selectively or changeably moved manually. The aforementioned structure is typical and will not be described in further details. The motorized wheel chair 1 further includes one or more (such as two) motor driving devices 30 attached to the drive wheels 20, and preferably disposed below the seat 11, and coupled to the wheel hubs or axles 21 of the drive wheels 20 respectively for automatically driving or rotating the drive wheels 20 respectively and for moving the wheel chair 1 everywhere.

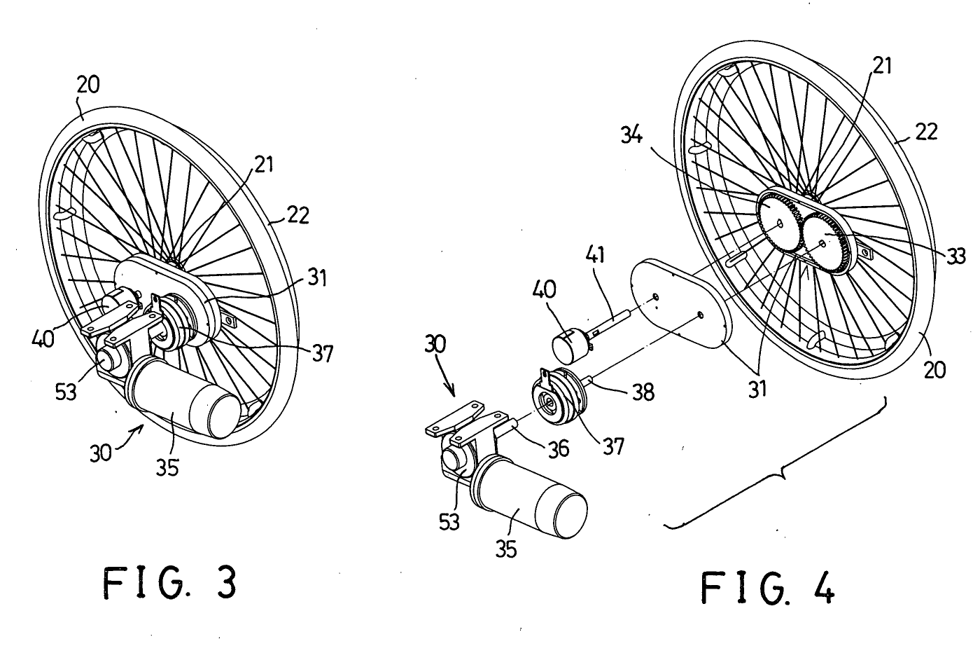

As shown in FIGS. 3 and 4, the motor driving devices 30 each include a housing 31 attached or secured to the drive wheel 20, two gear wheels or gears 33, 34 rotatably attached or disposed in the housing 31 or attached to the drive wheel 20 and meshed or engaged with each other, in which one of the gears 34 is secured to the wheel axle 21 of the drive wheel 20 and moved in concert with the wheel axle 21 of the drive wheel 20, for allowing the gear 33 to be rotated or driven by the gear 34 and the drive wheel 20, or relatively, for allowing the drive wheel 20 to be rotated or driven by the gears 33, 34 when required.

The motor driving devices 30 each further include a motor 35 attached or secured to the housing 31 and having a spindle 36 coupled to one of the gears 33 for driving or rotating the gears 33, 34 in order to drive or rotate the drive wheels 20 automatically. The spindle 36 of the motor 35 may be directly coupled to the gear 33 for driving or rotating the gears 33, 34; or may be indirectly coupled to the gear 33 with a clutch device 37 which is coupled between the spindle 36 of the motor 35 and the gear 33, and which includes a shaft 38 engaged into or through the housing 31 and meshed or engaged or coupled to the gear 33 for driving or rotating the gears 33, 34 and for driving or rotating the drive wheel 20. The motor 35 may include a reduction gearing (not shown) disposed or provided therein.

An encoder 40 may further be provided and attached or secured to the housing 31 and/or attached to the drive wheel 20, and includes a shaft or axle or rod 41 engaged into or through the housing 31 and meshed or engaged or coupled to the other gear 34 for allowing the encoder 40 to be selectively rotated or driven by the gears 33, 34 in order to detect or sense or measure the rotating angle of the drive wheel 20 and/or the moving distance of the drive wheel 20 and/or the moving speed of the drive wheel 20. One or more batteries 39 (FIG. 1) may further be provided and attached or disposed in the inner or lower portion of the frame 10, and preferably disposed below the seat 11, and electrically coupled to the motor 35 and the encoder 40 for supplying the electric power or energy to the motor 35 and the encoder 40 and the other electric parts or elements.

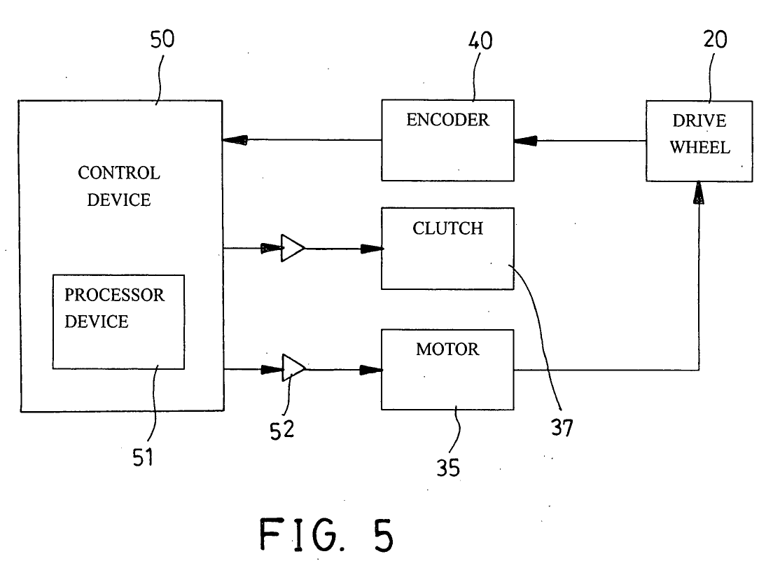

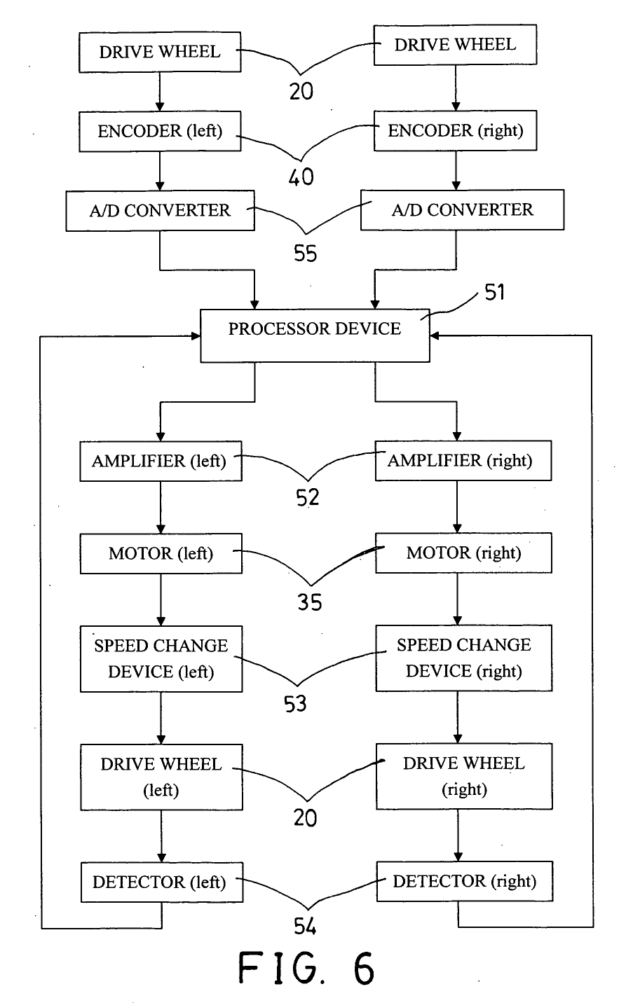

As shown in FIGS. 5 and 6, the motorized wheel chair 1 further includes a control device 50 (FIG. 5) coupled to the motors 35 and the encoders 40 and the clutch devices 37 for controlling the motors 35 to drive or to rotate the drive wheels 20 respectively, and the control device 50 includes a central processing unit or processor device 51 (FIGS. 5-6) coupled to the motors 35 directly, or indirectly with an amplifier 52, and the motors 35 may be coupled to the drive wheels 20 directly, or indirectly with a transmission device or speed change gear or device 53 which is attached to the motor 35. The control device 50 further includes a detector 54 coupled between the drive wheels 20 and the processor device 51 for sensing or detecting or measuring the rotating speed of the drive wheel 20.

The control device 50 further includes an A/D converter 55 coupled between the encoder 40 and the processor device 51 for supplying the suitable electric power or energy to the encoder 40, and the rod 41 or the encoder 40 is coupled to the drive wheel 20 and/or the gear 34 for sensing or detecting or measuring the rotating angle of the drive wheel 20, and/or the moving distance of the drive wheel 20 and/or the moving or rotating speed of the drive wheel 20, and the encoder 40 may send the detected message or information or signals to the processor device 51, and the processor device 51 may then determine or control the motors 35 to change the moving or rotating speed and/or the moving distance of the drive wheel 20 or the like.

The control device 50 may further include one or more switch buttons (not shown) attached to the frame 10 and disposed close to the side portion of the frame 10 for allowing the switch buttons to be easily operated by the users. The processor device 51 may control or actuate or operate the clutch devices 37 to be selectively coupled between the spindle 36 of the motor 35 and the gear 33 for allowing the gears 33, 34 and the drive wheel 20 to be driven or rotated by the motor 35; or to be selectively disconnected or opened for preventing the gears 33, 34 and the drive wheel 20 from being driven or rotated by the motor 35.

In operation, when the clutch devices 37 are disconnected or opened, the push rim 22 may be grasped or operated by the user to drive or to rotate the drive wheels 20. The processor device 51 may also be actuated by the switch buttons to operate the clutch devices 37 and to couple the gear 33 to the spindle 36 of the motor 35, and thus to allow the gears 33, 34 and the drive wheel 20 to be driven or rotated by the motor 35 selectively. When the user has no enough strength to rotate or operate the push rim 22, the encoder 40 may be arranged to send the detected message or information or signals to the processor device 51 and to drive or to rotate the drive wheels 20 with the motors 35 selectively. A low pass filter (not shown) may further be provided and engaged with the encoder 40 for preventing the encoder 40 from being operated inadvertently.

It is to be noted that the structure of the wheel chair 1, including the frame 10, the seat 11, the foot supports 12, the drive wheels 20, and the push rim 22, is not required to be changed or modified for fitting or attaching or mounting the motor driving devices 30 to the frame 10; i.e., the motor driving devices 30 may be easily and readily attached to the manually operated wheel chairs without changing much structure of the wheel chair.

Accordingly, the motorized wheel chair in accordance with the present invention includes a structure for allowing the wheel chair to be selectively or changeably moved or driven with a motor and to be selectively or changeably moved or driven manually.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A motorized wheel chair comprising:
a frame including a seat for supporting a user,
two drive wheels rotatably attached to said frame with wheel axles,
a push rim attached to each drive wheel for being operated by the user to rotate said drive wheels,
a motor driving device including a first gear secured to said wheel axle of said drive wheel and moved in concert with said wheel axle of said drive wheel, a motor attached to said drive wheel and engaged with said first gear for driving said drive wheel, and an encoder attached to said drive wheel and engaged with said first gear for detecting a rotating of said drive wheel, and
a control device including a processor device coupled to said motor and said encoder for receiving a signal from said encoder and for controlling said motor to operate said drive wheel.

2. The motorized wheel chair as claimed in claim 1, wherein said motor driving device includes a second gear attached to said drive wheel and engaged with said first gear for allowing said first and said second gears to be selectively driven by said drive wheel, and for allowing said drive wheel to be rotated by said first and said second gears selectively, said motor includes a spindle for coupling to said second gear.

3. The motorized wheel chair as claimed in claim 2, wherein said motor driving device includes a clutch device coupled between said spindle of said motor and said second gear.

4. The motorized wheel chair as claimed in claim 3, wherein said clutch device includes a shaft engaged with said second gear.

5. The motorized wheel chair as claimed in claim 2, wherein said encoder includes a rod engaged with said first gear.

6. The motorized wheel chair as claimed in claim 2, wherein said motor driving device includes a housing attached to said drive wheel, and said first and said second gears are rotatably disposed in said housing and engaged with each other.

7. The motorized wheel chair as claimed in claim 1, wherein said motor driving device includes a speed change device attached to said motor.
